(19) United States
(12) Patent Application Publication
(10) Pub. No.: US 2022/0298303 A1
(43) Pub. Date: Sep. 22, 2022

(54) POWDER COMPOSITION COMPRISING POLYIMIDE PARTICLES, THREE-DIMENSIONAL POLYIMDE-BASED BODY, AND METHOD OF FORMING THE BODY

(71) Applicant: Zymergen Inc., Emeryville, CA (US)

(72) Inventors: Patrick Gerardus Duis, Bergeijk (NL); John Colby Chastain, Oakland, CA (US); Justin Kerszulis, San Leandro, CA (US); Kenneth Kempinski, Mount Pleasant, SC (US)

(21) Appl. No.: 17/655,306

(22) Filed: Mar. 17, 2022

Related U.S. Application Data
(60) Provisional application No. 63/162,449, filed on Mar. 17, 2021.

(51) Int. Cl. C08G 73/10; B29C 64/153

(52) U.S. Cl. CPC C08G 73/1007; B29C 64/153; B29K 2279/08

(57) ABSTRACT

In one embodiment, a powder composition can comprise polyimide particles, wherein the polyimide particles can have a glass transition temperature of not greater than 200° C. and a crystallinity of not greater than 20%. The powder composition can be adapted for forming a three-dimensional polyimide-based body in a powder-based additive manufacturing process. In one aspect, the polyimide particles can have an average particle size (D50) of at least 20 microns and not greater than 120 microns, an amount of the polyimide particles can be at least 60 wt % based on the total weight of the powder composition; and a material of the polyimide particles is a polymerization product of at least one diamine monomer and at least one dianhydride monomer.

### CROSS-REFERENCE TO RELATED APPLICATION

This application claims priority under 35 U.S.C. § 119(e) to U.S. Provisional Application No. 63/162,449, entitled “POWDER COMPOSITION COMPRISING POLYIMIDE PARTICLES, THREE-DIMENSIONAL POLYMIDE-BASED BODY, AND METHOD OF FORMING THE BODY,” by Patrick Gerardus DUIS, et al., filed Mar. 17, 2021, which is assigned to the current assignee hereof and is incorporated herein by reference in its entirety.

### FIELD OF THE DISCLOSURE

The present disclosure relates to a powder composition comprising polyimide particles, a three-dimensional polyimide-based body, and a method of forming the three-dimensional polyimide-based body using the powder composition.

### BACKGROUND

High performance polymers made by powder-based additive manufacturing processes, such as selective laser sintering (SLS) or multi-jet fusion (MJF), have a large production increase since 2003 worldwide. Typical polymers used for SLS and MJF printing are polyamides, thermoplastic polyurethanes and polypropylene.

The majority of commercial SLS printing machines only work up to a maximum temperature of 200° C., while machines which can work at temperatures greater than 220° C. are much more expensive and therefore limited.

There exists a desire to form polyimide-based bodies via powder-based additive manufacturing processing, specifically manufacturing polyimide-based bodies using printing machines which work below a temperature of 200° C.

### SUMMARY

According to one embodiment, a powder composition can comprise polyimide particles, wherein the polyimide particles can have an average particle size (D50) of at least 20 microns and not greater than 100 microns; an amount of the polyimide particles may be at least 60 wt % based on the total weight of the powder composition; a crystallinity of the material of the polyimide particles can be not greater than 20%; and the glass transition temperature of the polyimide particles may be not greater than 200° C.

According to another embodiment, a powder composition can comprise polyimide particles, wherein the polyimide particles can have an average particle size (D50) of at least 20 microns and not greater than 100 microns; an amount of the polyimide particles can be at least 60 wt % based on the total weight of the powder composition; and the material of the polyimide particles can be a polymerization product of at least one diamine monomer and at least one dianhydride monomer, wherein the at least one diamine monomer is selected from

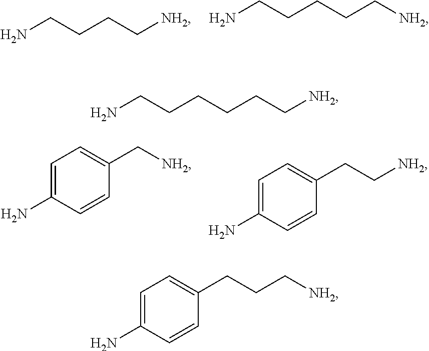

or any combination thereof.

In a further embodiment, the present disclosure is directed to a three-dimensional polyimide-based body, wherein the three-dimensional polyimide-based body can be formed by a powder-based additive manufacturing process; the polyimide-based body may have a heat deflection temperature (HDT) at 1.8 MPa of at least 120° C.; an amount of a polyimide in the polyimide-based body can be at least 60 wt %; and an onset melting point temperature of a material of the three-dimensional polyimide-based body is not greater than 220° C.

In another embodiment, the present disclosure is directed to a three-dimensional polyimide-based body, wherein the polyimide-based body can be formed by a powder-based additive manufacturing process; an amount of a polyimide in the polyimide-based body may be at least 60 wt %; and the polyimide can be a reaction product of a diamine monomer and dianhydride monomer, wherein the diamine monomer is selected from

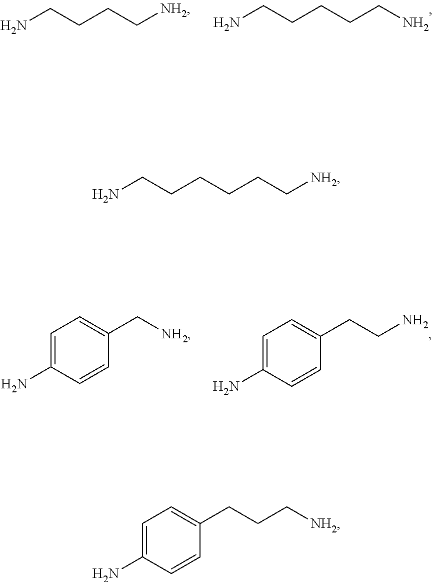 [SMILES: NCCCCN ; NCCCCCN ; NCCCCCCN ; NCc1ccc(N)cc1 ; NCCc1ccc(N)cc1 ; NCCCc1ccc(N)cc1]

or any combination thereof.

In another embodiment, a method of forming a three-dimensional polyimide-based body can comprise: providing a powder composition, wherein the powder composition can comprise polyimide particles in an amount of at least 60 wt % based on the total weight of the powder composition, a crystallinity of the polyimide particles may be not greater than 20%, and a glass transition temperature of the polyimide particles can be not greater than 200° C.; and forming the polyimide-based body by conducting a powder-based additive manufacturing process, wherein the three-dimensional polyimide-based body can have a heat deflection temperature (HDT) at 1.80 MPa of at least 120° C.

In a further embodiment, a method of forming a polyimide powder can comprise: solution polymerizing at least one diamine monomer and at least one dianhydride monomer to form a polyimide, wherein the diamine monomer can be selected from

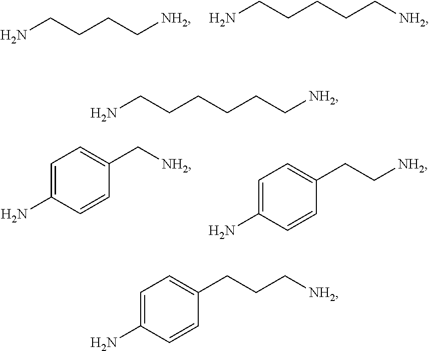

or any combination thereof;

and wherein solid polyimide particles may be formed by precipitation from the solution.

### BRIEF DESCRIPTION OF THE DRAWINGS

The present disclosure may be better understood, and its numerous features and advantages made apparent to those skilled in the art by referencing the accompanying drawings.

FIG. 1 includes an image illustrating the DSC curve of a powder composition according to one embodiment.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Various embodiments of the present disclosure will now be described, by way of example only, with reference to the accompanying drawings.

In one embodiment, the present disclosure relates to a powder composition comprising polyimide particles, wherein the powder composition is adapted for use in a powder-based additive manufacturing process.

As used herein, the term “powder composition”, if not indicated otherwise, refers to a powder containing as a majority polyimide particles (at least 5 lwt % based on the total weight of the powder composition).

As used herein, the term “polyimide particles”, if not indicated otherwise, refers to particles consisting essentially of polyimide. Consisting essentially of polyimide particles means that the material of the polyimide particles contain at least 95 wt % polyimide, such as at least 98 wt %, at least 99 wt %, or at least 99.9 wt % based on the total weight of the polyimide particles.

As used herein, a powder-based additive manufacturing process includes any additive manufacturing process which involves using a dry powder composition and includes selectively melting and/or fusing portions of the particles of the powder composition into a desired three-dimensional shape. Non-limiting examples of a powder-based additive manufacturing process can include selective laser sintering (SLS), multi-jet fusion (MJF), or high speed sintering (HSS).

In one embodiment, the powder composition of the present disclosure can contain polyimide particles in an amount of at least 60 wt %; an average particles size (D50) of the polyimide particles can be at least 20 microns and not greater than 100 microns; a glass transition temperature of the polyimide particles may be not greater than 200° C., and the crystallinity of the material of the polyimide particles may be not greater than 20%.

In a certain embodiment, the material of the polyimide particles of the powder composition can be a polymerization product of at least one diamine monomer and at least one dianhydride monomer.

In one aspect, the diamine monomer can include at least one diamine monomer selected from

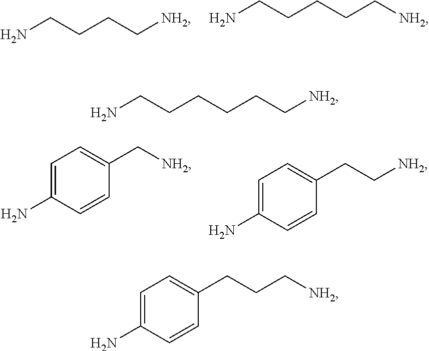

or any combination thereof.

In another aspect, the dianhydride monomer can have a structure of Formula (1) or Formula (2):

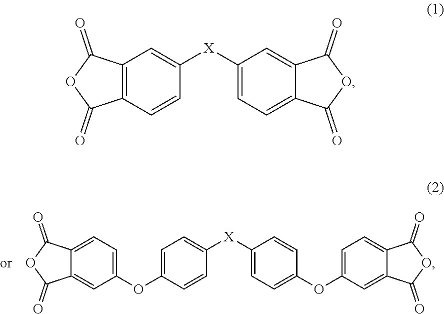

with X being CH₂, CO, O, SO₂, CHY, CY₂, or C₂-C₅ alkyl; Y being CH₃, CH₂F, CHF₂, or CF₃. In one aspect, X can be CH₂, CHY, CY₂, or C₂-C₅ alkyl, with Y being CH₃, CH₂F, CHF₂, or CF₃.

In a certain particular aspect, the polyimide particles can be a polymerization product of diamine

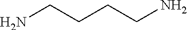

and dianhydride

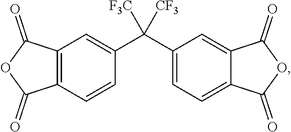 [SMILES: O=C1OC(=O)c2cc(C(c3ccc4c(c3)C(=O)OC4=O)(C(F)(F)F)C(F)(F)F)ccc21]

which leads to the polyimide of Formula (3):

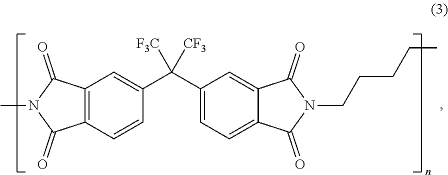

Methods for producing polyimides are well known to those of ordinary skill in the art, and any method may be employed to produce the polyimides of the present disclosure. In one aspect, the diamine and dianhydride monomers can be polymerized in high boiling solvents, such as dimethylacetamide (DMAc), N-methyl-2-pyrrolidone (NMP), or m-cresol, and obtain at elevated temperatures the imidized polymer directly. In another aspect, the diamine and dianhydride monomers may be polymerized at low temperatures in a polar aprotic solvent, such as DMAc or NMP below 80° C., to yield in a first step a polyamic acid, which is in a second step imidized either chemically or thermally.

A molar ratio of the at least one diamine monomer and the at least one dianhydride monomer can be between 0.9:1 and 1:6, in a particular aspect between 0.9:1 and 1:4, and in a certain particular aspect 0.9:1.05 to 0.95:1.1. After imidization, the obtained polyimides can be isolated by precipitation into a non-solvent (a liquid which does not dissolve the polyimide), for example, an alcohol. Typical non-solvents used for this purpose may be methanol, ethanol, or isopropanol.

In order to obtain a desired particle size distribution of the polyimide, the precipitation may be conducted in a controlled way. In one aspect, the particle size distribution can be controlled by precipitating at a solution temperature (herein also called precipitation temperature) of not greater than 75° C., or not greater than 50° C., or not greater than 30° C., or not greater than 20° C., or not greater than 15° C., or not greater than 10° C. In another aspect, the precipitation temperature can be at least 2° C., or at least 5° C. In a particular aspect, the precipitation temperature can be between 5° C. and 10° C.

In a further aspect, the concentration of the polyimide in the solution (which corresponds to the amount of precipitated polyimide), at the time of precipitation, can be at least 1 wt %, or at least 2 wt %, or at least 3 wt %, or at least 4 wt %, or at least 4.5 wt %. In another aspect, the concentration of the polyimide may be not greater than 30 wt %, or not greater than 20 wt %, or not greater than 15 wt %, or not greater than 10 wt %, or not greater than 7 wt %, or not greater than 5.5 wt %, or not greater than 5.2 wt %. In a certain aspect, the concentration of the polymide is at least 3 wt % and not greater than 10 wt %, or at least 3 wt % and not greater than 5.5 wt %.

Other ways of obtaining a desired particle size can be sieving, milling, or dissolving the polyimide in a solvent and conducting controlled spray drying. In a certain aspect, cryogenic milling can be conducted with addition of fumed silica to improve the powder flow.

It has been surprisingly observed that the polyimide particles of the present disclosure can have a property profile which makes them very suitable for use in a powder-based additive manufacturing process. In one aspect, the polyimide particles can be used for forming a powder composition adapted for selective laser sintering in a printing machine which does not require temperatures above 200° C., i.e., a standard machine with standard settings.

In one aspect, the powder composition can comprise at least 51 wt % polyimide particles based on the total weight of the powder composition, such as at least 55 wt %, at least 60 wt %, at least 65 wt %, at least 70 wt %, at least 75 wt %, at least 80 wt %, at least 85 wt %, at least 90 wt %, at least 95 wt %, at least 98 wt %, or at least 99 wt %. In another aspect, an amount of the polyimide particles in the powder composition may be not greater than 99 wt %, or not greater than 95 wt %, or not greater than 90 wt %, or not greater than 80 wt %, or not greater than 70 wt %, or not greater than 65 wt %, or not greater than 60 wt %, or not greater than 55 wt %. The amount of the polyimide particles in the composite powder can be a value within any of the minimum and maximum values noted above.

In another aspect, the crystallinity of the material of the polyimide particles can be not greater than 20%, such as not greater than 15%, not greater than 10%, not greater than 5%, or not greater than 1%. In a certain aspect, the material of the polyimide particles can be substantially amorphous. As used herein, “substantially amorphous” is understood as a polyimide material having a crystallinity below 5%. The crystallinity or amorphous character of the polyimide material is determined by DSC measurements.

In a further aspect, the glass transition temperature of the polyimide particles can be not greater than 200° C., such as not greater than 195° C., or not greater than 190° C., or not greater than 185° C., or not greater than 180° C., or not greater than 175° C., or not greater than 170° C. In another aspect, the glass transition temperature can be at least 130° C., or at least 140° C., or at least 150° C., or at least 160° C., or at least 170° C., or at least 180° C. The glass transition temperature can be a value between any of the minimum and maximum values noted above. As used herein, the glass transition temperature is determined by DSC measurement according to ISO 11356-2.

In another aspect, the onset melting temperature of the polyimide particles can be not greater than 210° C., or not greater than 205° C., or not greater than 200° C., or not greater than 195° C., or not greater than 190° C., or not greater than 185° C., or not greater than 180° C., or not greater than 175° C. In another aspect, the onset melting temperature of the polyimide particles may be at least 150° C., or at least 160° C., or at least 170° C., or at least 180° C., or at least 190° C. The onset melting temperature is determined by DSC measurement according to ISO 11357-3.

If the material of the polyimide particles is substantially amorphous, the glass transition temperature (Tg) can be in close proximity to the onset melting temperature (Tₒₘ) of the polyimide particles or the same. In one aspect, a temperature difference ΔT between T_{g} and Tₒₘ, (ΔT=Tₒₘ−T_{g}) can be at least 2° C., or at least 5° C., or at least 10° C., or at least 15° C. In another aspect, ΔT may be not greater than 30° C., or not greater than 20° C., or not greater than 15° C., or not greater than 10° C., or not greater than 5° C.

In a further embodiment, the molecular weight (M_{w}) of the polyimide particles can be at least 10,000 g/mol, or at least 30,000 g/mol, or at least 50,000 g/mol, or at least 100,000 g/mol, or at least 200,000 g/mol, or at least 300,000 g/mol, or at least 400,000 g/mol. In another embodiment, the molecular weight may be not greater than 800,000 g/mol, or not greater than 700,000 g/mol, or not greater than 500,000 g/mol, or not greater than 200,000 g/mol, or not greater than 100,000 g/mol. The molecular weight can be a value between any of the minimum and maximum values noted above. The molecular weight is determined according to size exclusion chromatography against a polystyrene standard.

In another embodiment, the polyimide particles of the present disclosure can have a relative viscosity of at least 1.1, or at least 1.3, or at least 1.5 or at least 1.8, or at least 2.0. In another embodiment, the relative viscosity of the polyimide particles may be not greater than 3.0, or not greater than 2.5, or not greater than 2.2. The relative viscosity is determined by dissolving 0.5 wt % of polyimide particles in 95 wt % m-cresol, and comparing the flow time through a capillary viscometer of the sample containing dissolved polyimide with the flow time of the pure solvent (not containing dissolved polyimide) according to ISO 307.

The particle size distribution of the polyimide particle contained in the powder composition of the present disclosure can be characterized by its the D10, D50, and D90 value, determined via laser diffraction according to ISO 13320-1. In one aspect, the average particle size (D50) of the polyimide particles can be at least 20 microns, such as at least 30 microns, at least 40 microns, at least 50 microns, or at least 60 microns. In another aspect the D50 particle size may be not greater than 120 microns, such as not greater than 100 microns, not greater than 80 microns, or not greater than 70 microns.

In a further aspect, the 10 percentile of the particle sizes (D10) of the polyimide particles can be at least 1 micron, or at least 5 microns, or at least 10 microns, or at least 15 microns. In yet another aspect, the D10 value may be not greater than 30 microns, such as not greater than 20 microns, or not greater than 15 microns, or not greater than 12 microns, or not greater than 10 microns.

In yet another aspect, the 90 percentile of the particle sizes (D90) of the polyimide particles can be at least 60 microns, or at least 80 microns, or at least 100 microns, or at least 120 microns, or at least 140 microns, or at least 160 microns. In a further aspect, the D90 value of the polyimide particles may be no greater than 200 microns, or not greater than 180 microns, or not greater than 160 microns, or not greater than 140 microns, or not greater than 120 microns, or not greater than 100 microns, or not greater than 80 microns.

In a further aspect, the size dispersion index (D90-D10/D50) of the polyimide particles can be not greater than 2.5, or not greater than 2.3, or not greater than 2.0, or not greater than 1.9

The powder composition of the present disclosure can include one or more additives. As used herein, an additive of the powder composition is any ingredient which does not contain a polyimide. The at least one additive can be an organic or an inorganic compound. Non-limiting examples of an additive can be, for example, a thermally conductive filler, an electrically conductive filler, an IR absorber, a flow aid, a flame retardant, a stabilizer (e.g., a UV stabilizer, or a heat stabilizer), an antioxidant, a color dye, or an electrostatic dissipative (ESD) additive. In particular examples, the additive can be selected from carbon fiber, glass fiber, glass beads, hollow glass beads, a ceramic, a mineral, mica, wollastonite, carbon nano tubes, graphite, graphene, graphene oxide, a metal, a metal alloy, or any combination thereof.

An amount of the at least one additive in the powder composition of the present disclosure can be at least 0.1 wt %, or at least 0.5 wt %, or at least 1 wt %, or at least 5 wt %, or at least 10 wt %, or at least 20 wt %, or at least 30 wt %. In another aspect, the amount of the additive can be not greater 49 wt %, or not greater than 45 wt %, or not greater than 40 wt %, or not greater than 30 wt %, or not greater than 20 wt %, or not greater than 10 wt %, or not greater than 5 wt %. The amount of the additive in the powder composition can be a value between any of the minimum and maximum values noted above.

The particle size of the additive can be in the same range as the particle size of the polyimide particles. In other aspects, the particles size of the additive, dependent on its function, may be much smaller than the polyimide particles, for example pigment dyes.

The present disclosure is further directed to a three-dimensional polyimide-based body formed by a powder-based additive manufacturing process.

In one embodiment, the three-dimensional polyimide-based body can have a heat deflection temperature (HDT) at 1.8 MPA of at least 120° C.; an amount of the polyimide in the polyimide-based body may be at least 60 wt % based on the total weight of the polyimide-based body; and an onset melting temperature of the three-dimensional polyimide-based body may be not greater than 220° C.

In a particular embodiment, the three-dimensional polyimide-based body can be formed using the above-described powder composition of the present disclosure.

In one aspect, the powder-based additive manufacturing process for forming the three-dimensional polyimide-based body can be a selective laser sintering (SLS) process.

In another aspect, the powder-based additive manufacturing process for forming the three-dimensional polyimide-based body may be a multi-jet fusion (MJF) process. The fusion during an MJF process can be created by applying a fluid containing an activator on each powder layer at specific regions selected for fusion, and the powder fusion can be initiated by infrared radiation.

It has been surprisingly observed that the three-dimensional polyimide-based body of the present disclosure can have a unique property profile and may be produced in an efficient and economic way. For example, in one aspect, the three-dimensional polyimide-based body can be manufactured by a selective laser sintering process using a standard SLS printing machine which has a maximum operation temperature of not greater than 200° C.

In one aspect, the density of a material of the polyimide-based body can be at least 0.2 g/cm³, such as at least 0.5 g/cm³, at least 1.0 g/cm³, at least 1.5 g/cm³, at least 1.8 g/cm³, at least 1.9 g/cm³, at least 2.0 g/cm³, or at least 2.1 g/cm³.

In a further aspect, the tensile strength of the polyimide-based body in x-y direction according to ASTM D897-08 can be at least 80 MPa, such as at least 90 MPa, at least 100 MPa, at least 110 MPa, or at least 120 MPa. As used herein, x-y direction of the polyimide-based body means the length and width of the body, and the z-direction relates to the height of the body, and the body is built layer by layer during the powder-based additive manufacturing process in z-direction. The tensile strength of the polyimide-based body in z-direction can be at least 20% of the tensile strength in x-y direction, such as at least 30%, at least 40%, at least 50%, at least 60%, at least 70%, at least 80%, at least 90%, or the same compared to the x-y direction.

In another aspect, the flexural modulus of the polyimide-based body in x-y direction according to ASTM D790 can be at least 4500 GPa, or at least 5000 GPa, or at least 5500 GPa, or at least 6000 GPa, or at least 6500 GPa, or at least 7000 GPa, or at least 7500 Gpa, or at least 7500 GPa, or at least 8000 GPa, or at least 8500 GPa, or at least 9000 GPa, or at least 9500 GPa. In a further aspect, the flexural modulus of the polyimide-based body in x-y direction may be not greater than 25,000 GPa or not greater than 20,000 GPa or not greater than 15,000 GPa. The flexural modulus of the polyimide-based body in z-direction can be at least 20% of the flexural modulus in x-y direction, such as at least 30%, at least 40%, at least 50%, at least 60%, at least 70%, at least 80%, at least 90%, or the same compared to the x-y direction.

In a further aspect, the elongation at break of the polyimide-based body in x-y direction according to ASTM D5034-09 can be at least 2%, or at least 3%, or at least 5%, or at least 10%, or at least 15%, or at least 20%, or at least 30%, or at least 50%. In another aspect, the elongation at break of the polyimide-based body in x-y direction may be not greater than 200%, or not greater than 100%, or not greater than 50%, or not greater than 30% The elongation at break of the polyimide-based body in z-direction can be at least 20% of the elongation at break in x-y direction, such as at least 30%, at least 40%, at least 50%, at least 60%, at least 70%, at least 80%, at least 90%, or the same compared to the x-y direction.

In yet another aspect, a continued use temperature (CUT) of the polyimide-based body can be greater than 150° C., the CUT being defined as a temperature at which the body is continuously exposed for a time of 1000 hours without decreasing in the flexural modulus by more than 50% of the initial flexural modulus.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. A powder composition comprising polyimide particles, wherein the polyimide particles have an average particle size (D50) of at least 20 microns and not greater than 120 microns; an amount of the polyimide particles is at least 60 wt % based on the total weight of the powder composition; a crystallinity of a material of the polyimide particles is not greater than 20%; and a glass transition temperature of the polyimide particles is not greater than 200° C.

Embodiment 2. A powder composition comprising polyimide particles, wherein the polyimide particles have an average particle size (D50) of at least 20 microns and not greater than 120 microns; an amount of the polyimide particles is at least 60 wt % based on the total weight of the powder composition; and a material of the polyimide particles is a polymerization product of at least one diamine monomer and at least one dianhydride monomer, wherein the at least one diamine monomer is selected from

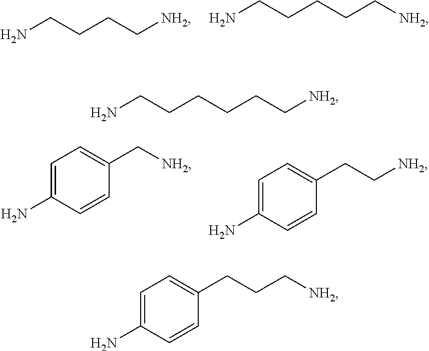

or any combination thereof.

Embodiment 3. The powder composition of Embodiment 2, wherein the dianhydride monomer has a structure of formula (1) or formula (2):

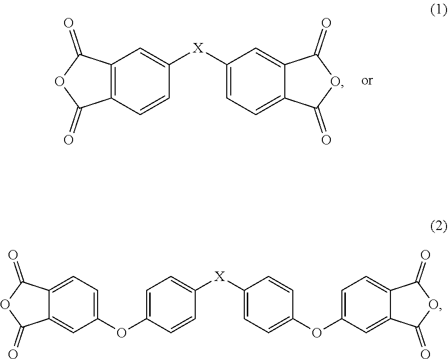

with X being CH₂, CO, O, SO₂, CHY, CY₂, or C₂-C₅ alkyl; Y being CH₃, CH₂F, CHF₂, or CF₃.

Embodiment 4. The powder composition of Embodiments 2 or 3, wherein the dianhydride monomer is selected from

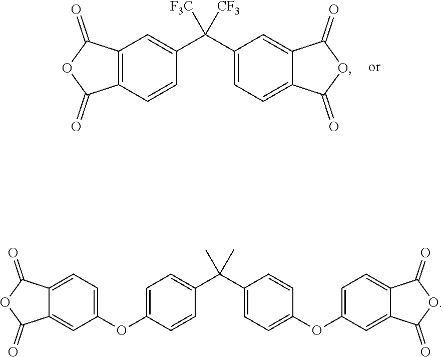 [SMILES: O=C1OC(=O)c2cc(C(c3ccc4c(c3)C(=O)OC4=O)(C(F)(F)F)C(F)(F)F)ccc21 ; "or" ; CC(C)(c1ccc(Oc2ccc3c(c2)C(=O)OC3=O)cc1)c1ccc(Oc2ccc3c(c2)C(=O)OC3=O)cc1]

Embodiment 5. The powder composition of any one of Embodiments 2-4, wherein a molar ratio of the at least one diamine monomer to the at least one dianhydride monomer is between 0.9:1.1 and 0.95:4.

Embodiment 6. The powder composition of any one of Embodiments 2-5, wherein a crystallinity of the material of the polyimide particles is not greater than 20%, and a glass transition temperature of the polyimide particles is not greater than 200° C.

Embodiment 7. The powder composition of Embodiments 1 or 6, wherein the crystallinity of the material of the polyimide particles is not greater than 15%, or not greater 10%, or not greater than 8%, or not greater than 5%, or not greater than 3%, or not greater than 1%.

Embodiment 8. The powder composition of any one of the preceding Embodiments, wherein the polyimide particles are substantially amorphous.

Embodiment 9. The powder composition of Embodiments 1 or 6, wherein the glass transition temperature of the polyimide particles is not greater than 195° C., or not greater than 190° C., or not greater than 185° C., or not greater than 180° C., or not greater than 175° C., or not greater than 170° C.

Embodiment 10. The powder composition of Embodiments 1 or 6, wherein the glass transition temperature of the polyimide particles is at least 130° C., or at least 140° C., or at least 150° C., or at least 160° C.

Embodiment 11. The powder composition of any one of the preceding Embodiments, wherein an onset melting point (Tₒₘ) of the polyimide particles is at least 150° C., or at least 160° C., or at least 170° C., or at least 180° C., or at least 190° C., or at least 195° C.

Embodiment 12. The powder composition of any one of the preceding Embodiments, wherein an onset melting point (Tₒₘ) of the polyimide particles is not greater than 210° C., or not greater than 205° C., or not greater than 200° C., or not greater than 190° C., or not greater than 180° C., or not greater than 175° C.

Embodiment 13. The powder composition of Embodiments 11 or 12, wherein a difference between the onset melting temperature (Tₒₘ) and the glass transition temperature (T_{g}) of the polyimide particles is not greater than 30° C., or not greater than 20° C., or not greater than 15° C., or not greater than 10° C., or not greater than 5° C., or not greater than 3° C.

Embodiment 14. The powder composition of Embodiments 11 or 12, wherein a difference between the onset melting temperature (Tₒₘ) and the glass transition temperature (T_{g}) of the polyimide particles is at least 2° C., or at least 4° C., or at least 6° C., or at least 8° C., or at least 10° C., or at least 15° C.

Embodiment 15. The powder composition of any one of the preceding Embodiments, wherein a molecular weight of the polyimide particles is at least 10,000 g/mol, or at least 30,000 g/mol, or at least 50,000 g/mol, or at least 100,000 g/mol, or at least 200,000 g/mol, or at least 300,000 g/mol, or at least 400,000 g/mol.

Embodiment 16. The powder composition of any one of the preceding Embodiments, wherein a molecular weight of the polyimide particles is not greater than 800,000 g/mol, or not greater than 700,000 g/mol, or not greater than 500,000 g/mol, or not greater than 200,000 g/mol, or not greater than 100,000 g/mol.

Embodiment 17. The powder composition of any one of the preceding Embodiments, wherein a relative viscosity of the polyimide particles is at least 1.1 or at least 1.3, or at least 1.5, or at least 1.5, or at least 1.8, or at least 2.0, the relative viscosity being measured in m-cresol according to ISO 307.

Embodiment 18. The powder composition of any one of the preceding Embodiments, wherein a relative viscosity is not greater than 3.0, or not greater than 2.5, or not greater than 2.2, the relative viscosity being measured in m-cresol according to ISO 307.

Embodiment 19. The powder composition of any one of the preceding Embodiments, wherein a bulk density of the powder composition is at least 0.3 g/cm³, such as at least 0.4 g/cm³, or at least 0.5 g/cm³, or at least 0.6 g/cm³.

Embodiment 20. The powder composition of any one of the preceding Embodiments, wherein a bulk density of the powder composition is not greater than 1.2 g/cm³, or not greater than 0.95 g/cm³, or not greater than 0.9 g/cm³, or not greater than 0.8 g/cm³, or not greater than 0.7 g/cm³, or not greater than 0.6 g/cm³.

Embodiment 21. The powder composition of any one of the preceding Embodiments, wherein an average particle size (D50) of the polyimide particles is at least 20 microns, such as at least 30 microns, at least 40 microns, at least 50 microns, or at least 60 microns.

Embodiment 22. The powder composition of any one of the preceding Embodiments, wherein an average particle size (D50) of the polyimide particles is not greater than 120 microns, such as not greater than 100 microns, not greater than 80 microns, or not greater than 70 microns.

Embodiment 23. The powder composition of any one of the preceding Embodiments, wherein a 10 percentile of the particle sizes (D10) of the polyimide particles is at least 1 micron, or at least 5 microns, or at least 10 microns, or at least 15 microns.

Embodiment 24. The powder composition of any one of the preceding Embodiments, wherein a 10 percentile of the particles sizes (D10) of the polyimide particles is not greater than 30 microns, or not greater than 25 microns, or not greater than 20 microns, or not greater than 10 microns.

Embodiment 25. The powder composition of any one of the preceding Embodiments, wherein a 90 percentile of the particles sizes (D90) of the polyimide particle is at least 60 microns, or at least 80 microns, or at least 100 microns, or at least 120 microns, or at least 140 microns, or at least 160 microns.

Embodiment 26. The powder composition of any one of the preceding Embodiments, wherein a 90 percentile of the particles sizes (D90) of the polyimide particles is not greater than 200 microns, or not greater than 180 microns, or not greater than 160 microns, or not greater than 140 microns, or not greater than 120 microns, or not greater than 100 microns, or not greater than 80 microns.

Embodiment 27. The powder composition of any one of the preceding Embodiments, wherein a size dispersion index (D90-D10/D50) of the polyimide particles is not greater than 2.5, or not greater than 2.3, or not greater than 2.0, or not greater than 1.9.

Embodiment 28. The powder composition of any one of the preceding Embodiments, further comprising an organic or inorganic additive.

Embodiment 29. The powder composition of Embodiment 28, wherein the additive includes a thermally conductive filler, an electrically conductive filler, an IR absorber, a flow aid, a flame retardant, a stabilizer, a color dye, or an electrostatic dissipative (ESD) additive.

Embodiment 30. The powder composition of Embodiments 28 or 29, wherein the additive is selected from carbon fibers, glass fibers, glass beads, hollow glass beads, a UV stabilizer, a heat stabilizer, a ceramic, a mineral, mica, wollastonite, carbon nano tubes, graphite, graphene, graphene oxide, a metal, a metal alloy, or any combination thereof.

Embodiment 31. The powder composition of any one of Embodiments 28-30, wherein an amount of the additive is not greater than 40 wt % based on the total weight of the powder composition, such as not greater than 30 wt %, not greater than 20 wt %, not greater than 10 wt %, not greater than 5 wt %, of not greater than 1 wt %.

Embodiment 32. The powder composition of any one of Embodiments 1-27, wherein the powder composition consists essentially of the polyimide particles.

Embodiment 33. A three-dimensional polyimide-based body, wherein the polyimide-based body is formed by a powder-based additive manufacturing process; the polyimide-based body has a heat deflection temperature (HDT) at 1.8 MPa of at least 120° C.; an amount of a polyimide in the polyimide-based body is at least 60 wt % based on the total weight of the polyimide-based body; and an onset melting point temperature of a material of the three-dimensional body is not greater than 220° C.

Embodiment 34. A three-dimensional polyimide-based body, wherein the polyimide-based body is formed by a powder-based additive manufacturing process; an amount of a polyimide in the polyimide-based body is at least 60 wt %; and the polyimide is a reaction product of a diamine monomer and dianhydride monomer, wherein the diamine monomer is selected from

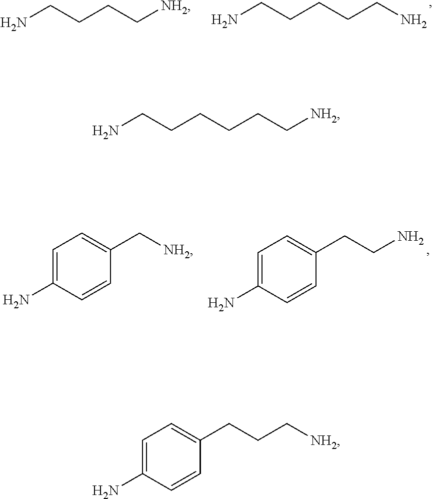

or any combination.

Embodiment 35. The three-dimensional polyimide-based body of Embodiments 33 or 34, wherein the powder-based additive manufacturing process is a selective laser sintering (SLS) process.

Embodiment 36. The three-dimensional polyimide-based body of Embodiments 34 or 34, wherein the powder-based additive manufacturing process is a multi-jet fusion (MJF) process.

Embodiment 37. The three-dimensional polyimide-based body of any one of Embodiments 34-36, wherein the polyimide-based body has a heat deflection temperature (HDT) at 1.8 MPa of at least 120° C.

Embodiment 38. The three-dimensional polyimide-based body of Embodiments 33 or 37, wherein the HDT at 1.8 MPa is at least 130° C., or at least 150° C., or at least 160° C., or at least 170° C., or at least 180° C.

Embodiment 39. The three-dimensional polyimide-based body of one of Embodiments 34-38, wherein an onset melting temperature of a material of the polyimide-based body is not greater than 220° C.

Embodiment 40. The three-dimensional polyimide-based body of any one of Embodiments 33 or 39, wherein the onset melting temperature of the material of the polyimide-based body is not greater than 210° C., or not greater than 200° C., or not greater than 190° C., or not greater than 180° C.

Embodiment 41. The three-dimensional polyimide-based body of Embodiment 33, wherein the polyimide of the polyimide-based body is a polymerization product of at least one diamine monomer and at least one dianhydride monomer, the diamine monomer being selected from

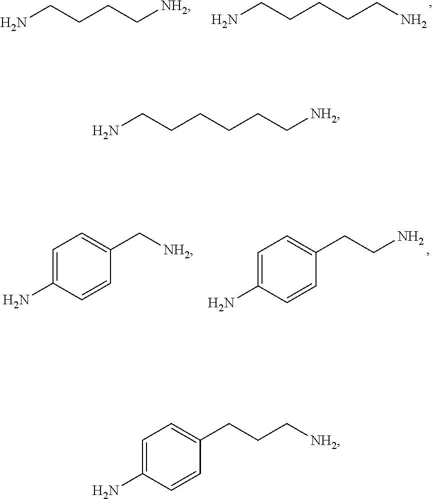

or any combination thereof.

Embodiment 42. The three-dimensional polyimide-based body of any one of Embodiments 34-41, wherein the dianhydride monomer has a structure of formula (1) or formula (2):

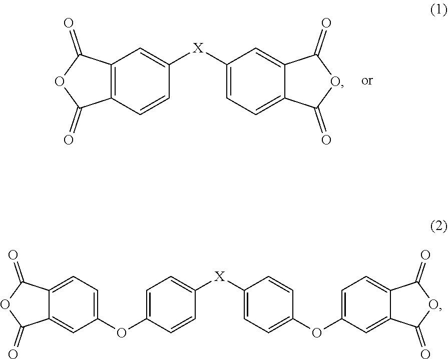

with X being CH₂, CO, O, SO₂, CHY, CY₂, or C₂-C₅ alkyl, Y being CH₃, CH₂F, CHF₂, or CF₃.

Embodiment 43. The three-dimensional polyimide-based body of any one of Embodiments 33-42, wherein the polyimide-based body further comprises an organic or inorganic additive.

Embodiment 44. The three-dimensional polyimide-based body of any one of Embodiment 43, wherein the additive includes a thermally conductive filler, an electrically conductive filler, an IR absorber, a flow aid, a flame retardant, a stabilizer, a color dye, or an electrostatic dissipative (ESD) additive.

Embodiment 45. The three-dimensional polyimide-based body of any one of Embodiments 43 or 44, wherein the additive is selected from carbon fibers, glass fibers, glass beads, hollow glass beads, a ceramic, a mineral, mica, wollastonite, carbon nano tubes, graphite, graphene, a metal, a metal alloy or any combination thereof.

Embodiment 46. The three-dimensional polyimide-based body of any one of Embodiments 33-42, wherein the three-dimensional body consists essentially of the polyimide.

Embodiment 47. The three-dimensional polyimide-based body of any one of Embodiments 33-46, wherein a density of a material of the polyimide-based body is at least 0.2 g/cm³, such as at least 0.5 g/cm³, at least 1.0 g/cm³, at least 1.5 g/cm³, at least 1.8 g/cm³, at least 1.9 g/cm³, at least 2.0 g/cm³, or at least 2.1 g/cm³.

Embodiment 48. The three-dimensional polyimide-based body of any one of Embodiments 33-47, wherein a tensile strength of the polyimide-based body in x-y direction according to ASTM D638 is at least 80 MPa, such as at least 90 MPa, at least 100 MPa, at least 110 MPa, or at least 120 MPa.

Embodiment 49. The three-dimensional polyimide-based body of any one of Embodiments 33-48, wherein a flexural modulus of the polyimide-based body in x-y direction according to ASTM D790 is at least 4500 GPa, or at least 5000 GPa, or at least 5500 GPa, or at least 6000 GPa, or at least 6500 GPa, or at least 7000 GPa, or at least 7500 Gpa, or at least 7500 GPa, or at least 8000 GPa, or at least 8500 GPa, or at least 9000 GPa, or at least 9500 GPa.

Embodiment 50. The three-dimensional polyimide-based body of any one of Embodiments 33-49, wherein a flexural modulus of the polyimide-based body in x-y direction according to ASTM D790 is not greater than 30,000 GPa or not greater than 20,000 GPa, or not greater than 15,000 GPa.

Embodiment 51. The three-dimensional polyimide-based body of any one of Embodiments 33-50, wherein an elongation at break of the polyimide-based body in x-y direction according to ASTM D638 is at least 2%, or at least 3%, or at least 5%, or at least 10%, or at least 15%, or at least 20%, or at least 30%, or at least 50%.

Embodiment 52. The three-dimensional polyimide-based body of any one of Embodiments 33-51, wherein an elongation at break of the polyimide-based body according in x-y direction to ASTM D638 is not greater than 200%, or not greater than 100%, or not greater than 50%, or not greater than 30%.

Embodiment 53. The three-dimensional polyimide-based body of any one of Embodiments 33-52, wherein a continued use temperature (CUT) of the polyimide-based body is greater than 150° C., the CUT being defined as a temperature at which the body is continuously exposed for a time of 1000 hours without decreasing in a tensile strength by more than 50%.

Embodiment 54. A method of forming a three-dimensional polyimide-based body, the method comprising: providing a powder composition, wherein the powder composition comprises polyimide particles in an amount of at least 60 wt % based on the total weight of the powder composition, a crystallinity of the polyimide particles is not greater than 20%, and a glass transition temperature of the polyimide particles is not greater than 190° C.; and forming the polyimide-based body by conducting a powder-based additive manufacturing process, wherein the polyimide-based body has a heat deflection temperature (HDT) at 1.80 MPa of at least 120° C.

Embodiment 55. The method of Embodiment 54, wherein the powder-based additive manufacturing process is a selective laser sintering (SLS) process.

Embodiment 56. The method of Embodiment 54, wherein the powder-based additive manufacturing process is a multi-jet fusion (MJF) process.

Embodiment 57. The method of Embodiment 54, wherein the powder-based additive manufacturing process is a high speed sintering (HSS) process.

Embodiment 58. The method of any one of Embodiments 54-57, wherein the powder composition comprises a characteristic of the powder composition of any one of Embodiments 1-24.

Embodiment 59. The method of any one of Embodiments 54-58, wherein the polyimide-based body comprises a characteristic of the three-dimensional polyimide-based body of any one of Embodiments 33-53.

Embodiment 60. The method of any one of Embodiments 54-59, wherein a recycling rate of polyimide particles of a remaining powder composition after forming of the polyimide-based body is at least 70%, such as at least 80%, at least 90%, at least 95%, or 100, the remaining powder composition being exposed to the forming process but not fused to the polyimide-based body.

Embodiment 61. A method of forming a polyimide powder, comprising: solution polymerizing at least one diamine monomer and at least one dianhydride monomer to form a polyimide, wherein the diamine monomer is selected from

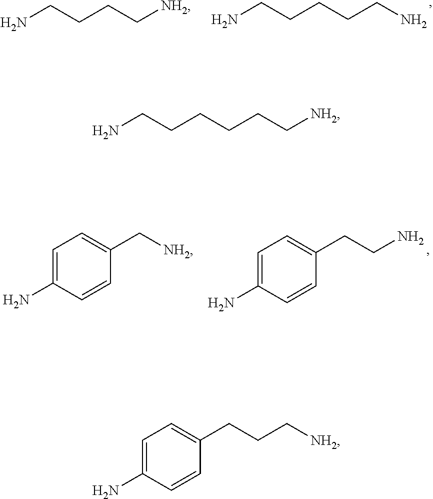

or any combination thereof;

and wherein solid polyimide particles are formed by precipitation from the solution.

Embodiment 62. The method of Embodiment 61, wherein the dianhydride monomer has a structure of formula (1) or formula (2):

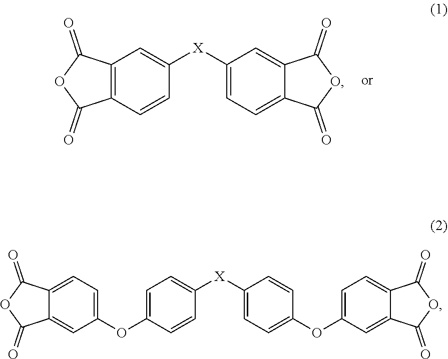

with X being CH₂, CO, O, SO₂, CHY, CY₂, or C₂-C₅ alkyl; Y being CH₃, CH₂F, CHF₂, or CF₃.

Embodiment 63. The method of Embodiments 61 or 62, wherein the dianhydride monomer is selected from

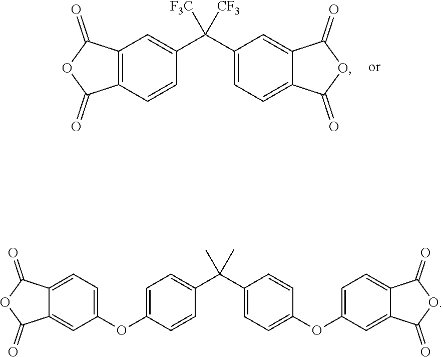 [SMILES: O=C1OC(=O)c2cc(C(c3ccc4c(c3)C(=O)OC4=O)(C(F)(F)F)C(F)(F)F)ccc21 ; "or" ; CC(C)(c1ccc(Oc2ccc3c(c2)C(=O)OC3=O)cc1)c1ccc(Oc2ccc3c(c2)C(=O)OC3=O)cc1]

Embodiment 64. The method of any one of Embodiments 61-63, wherein precipitation from solution is conducted at a precipitation temperature (Tₚ) of at least 5° C. to not greater than 75° C.

Embodiment 65. The method of Embodiment 64, wherein the precipitation temperature is not greater than 50° C., or not greater than 40° C., or not greater than 30° C., or not greater than 25° C., or not greater than 20° C., or not greater than 15° C., or not greater than 10° C.

Embodiment 66. The method of any one of Embodiments 61-65, wherein a concentration of the polyimide particles after precipitation is at least 1 wt % and not greater than 10 wt % based on a total weight of the solution.

Embodiment 67. The method of Embodiment 66, wherein the concentration of the polyimide particles is not greater than 30 wt %, or not greater than 20 wt %, or not greater than 10 wt %, or not greater than 8 wt %, or not greater than 6 wt %, or not greater than 5.5 wt %, or not greater than 5.2 wt %, or not greater than 5.0 wt %.

Embodiment 68. The method of Embodiment 67, wherein the concentration of the polyimide particles ranges from 3 wt % to 5.5 wt %.

### EXAMPLES

### Example 1

Preparing of Polyimide Particles

Into a 3 neck flask equipped with a reflux condenser and an overhead stirrer with thermometer and torque display, 4,4′-(hexafluoroisopropylidene)diphthalic anhydride (6-FDA) (44.42 g, 100 mmol, 1 eq) and 190 mL m-cresol were combined under nitrogen atmosphere. Thereafter, 95 mmol (8.15 g, 95 mol %) of 1,4-diaminobutane (DAB) was added to the reaction flask. The DAB was added as a 0.5 M solution in m-cresol (12 mL) via dropping funnel under nitrogen atmosphere. After adding the DAB, the flask content was stirred and heated to 155° C. and maintained for at least 1.5 hours at this temperature. Thereafter, the reaction was stopped by cooling to a selected precipitation temperature (Tp) in a range between 5° C. and about 50° C. (see Table 1). During cooling an amount of 100 ml Cresol was added, and the polyimide quenched (precipitated) with about 700 mL isopropanol at an addition rate of about 60 ml/minute, thereby precipitating a colorless powder of the polyimide. The method was designed that the concentration of the precipitated polyimide particles in the dispersion was not greater than 5.15 wt % based on the total weight of the dispersion. The precipitated particles were washed in a Buchner funnel using 70 v/v % denatured ethanol and dried in a vacuum oven at 160° C. The residual solvent content after drying was below 0.2 wt % based on the total weight of the powder.

The precipitation temperature was varied for different samples, as summarized in Table 1. It can be seen that the lowest precipitation temperature (5-10° C.) lead to the smallest particle sizes (D10, D50, and D90).

The obtained polyimide contained the recurring structure unit of Formula (3):

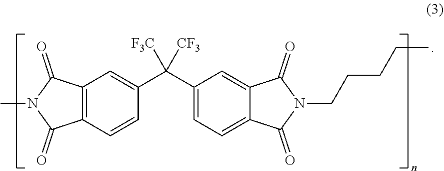

### Example 2

Properties of Polyimide Particles PI-1

The polyimide particles of sample PI-1, C1 and C2 obtained in Example 1 were analyzed by its particle size distribution (D10, D50, and D90) via light scattering with a Malvern Mastersizer 3000 instrument. A summary of the size distributions can be seen in Table 1.

TABLE 1

| Property | PI-1 | C1 | C2 |
|---|---|---|---|
| Dᵥ10 [microns] | 27.4 | 90.7 | 187 |
| Dᵥ50 [microns] | 53.5 | 138 | 401 |
| Dᵥ90 [microns] | 127.0 | 209 | 1250 |
| Size Dispersion Index | 1.86 | 0.85 | 2.65 |
| (D90-D10/D50) | | | |
| Glass Transition Temperature | 189 | 189 | 189 |
| (Tg) [° C.] | | | |
| Precipitation Temperature [° C.] | 5-10 | 20-25 | 40-45 |
| Concentration of precipitated | 4.93 | 5.02 | 4.82 |
| polyimide particles [wt %] | | | |

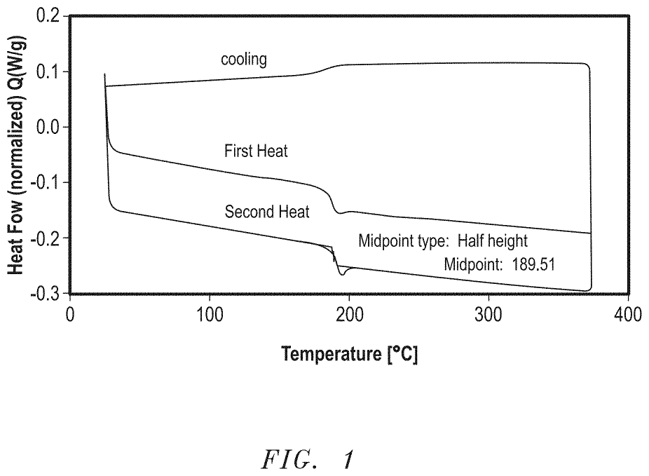

Furthermore, the glass transition temperature (T_{g}) was determined by analyzing the powders via differential scanning calorimetry (DSC). A DSC curve of a powder sample of PI-1 can be seen in FIG. 1. The powder sample was heated at a speed of 10° C./minute up to about 380° C. and the heat flow corresponding normalized heat flow was measured. It can be seen that the Tg is reversible, and is at the same temperature when a second heating was conducted, indicating thermoplastic behavior. Upon cooling, no crystallization peak could be observed, but the material rehardened at the Tg. This indicates that the powder sample is highly amorphous.

The samples summarized in Table 1 all have the same glass transition temperature but distinguish by the particles size distribution.

### Example 3

Forming of Three-Dimensional Polyimide-Based Body Via Selective Laser Sintering (SLS)

A three-dimensional polyimide-based body was printed via selective laser sintering (SLS) using the polyimide particles of sample PI-1 and comparative sample C1 from Example 1.

The SLS printing was conducted in a standard type machine, EOSINT P 395 from EOS. The fusing during printing was conducted with a CO₂ laser at a power of 50-55 watt. The temperature during applying the powder layers (powder bed) was about 140° C. The selective laser sintering was conducted close to the glass transition temperature (189° C. of the sample). The obtained three-dimensional polyimide-based body met the expectations with regard to strength, flexibility and shape resolution.

It was not possible to print with the powder of comparative sample C1 a three-dimensional body via the above-described SLS printing method.

### Example 4

Recycling of Powder Composition

The powder composition used for the forming of the three-dimensional polyimide-based body of Example 3, but which is not fused by the laser to the formed body and is removed after the SLS printing from the printed body (hereinafter called “used powder composition”) is evaluated regarding changes in the relative viscosity and the glass transition temperature in comparison to the powder composition used as starting material and not exposed to the printing conditions.

It is observed that the relative viscosity and the glass transition temperature of the used powder composition is changed only very minor if compared to these properties of the original starting powder composition. Accordingly, it is possible to reuse the used powder composition for forming a three-dimensional body via SLS printing with about same property profile as described in Example 2.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

What is claimed is:

1. A powder composition comprising polyimide particles, wherein
the polyimide particles have an average particle size (D50) of at least 20 microns and not greater than 120 microns;
an amount of the polyimide particles is at least 60 wt % based on the total weight of the powder composition; and
a material of the polyimide particles is a polymerization product of at least one diamine monomer and at least one dianhydride monomer, wherein the at least one diamine monomer is selected from 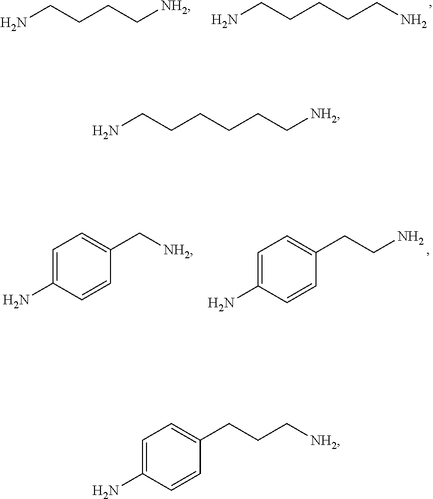
or any combination thereof.

2. The powder composition of claim 1, wherein the dianhydride monomer has a structure of formula (1) or formula (2): 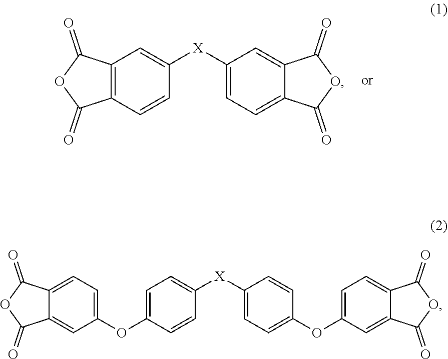
with X being CH₂, CO, O, SO₂, CHY, CY₂, or C₂-C₅ alkyl; Y being CH₃, CH₂F, CHF₂, or CF₃.

3. The powder composition of claim 2, wherein the dianhydride monomer is selected from

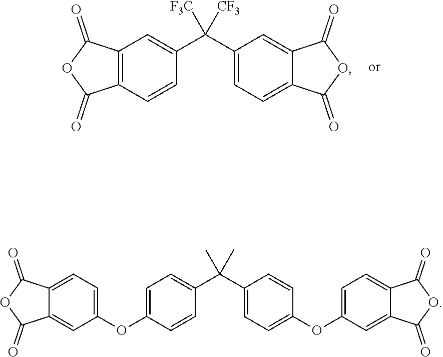 [SMILES: O=C1OC(=O)c2cc(C(c3ccc4c(c3)C(=O)OC4=O)(C(F)(F)F)C(F)(F)F)ccc21 ; "or" ; CC(C)(c1ccc(Oc2ccc3c(c2)C(=O)OC3=O)cc1)c1ccc(Oc2ccc3c(c2)C(=O)OC3=O)cc1]

4. The powder composition of claim 1, wherein a glass transition temperature of the polyimide particles is at least 130° C. and not greater than 200° C.

5. The powder composition of claim 1, wherein a difference between the onset melting temperature (Tₒₘ) and the glass transition temperature (T_{g}) of the polyimide particles is not greater than 20° C.

6. The powder composition of claim 1, wherein a molecular weight of the polyimide particles is at least 10,000 g/mol and not greater than 800,000 g/mol.

7. The powder composition of claim 1, further comprising an additive, the additive including a thermally conductive filler, an electrically conductive filler, a flow aid, a flame retardant, an IR absorber, a stabilizer, a color dye, an electrostatic dissipative (ESD) additive, or any combination thereof.

8. The powder composition of claim 7, wherein the additive is selected from carbon fibers, glass fibers, glass beads, hollow glass beads, a UV stabilizer, a heat stabilizer, a ceramic, a mineral, mica, wollastonite, carbon nano tubes, graphite, graphene, graphene oxide, a metal, a metal alloy, or any combination thereof.

9. The powder composition of claim 7, wherein an amount of the additive is not greater than 40 wt % based on the total weight of the powder composition.

10. The powder composition of claim 1, wherein the powder composition consists essentially of the polyimide particles.

11. A powder composition comprising polyimide particles, wherein
the polyimide particles have an average particle size (D50) of at least 20 microns and not greater than 120 microns;
an amount of the polyimide particles is at least 60 wt % based on the total weight of the powder composition;
a crystallinity of a material of the polyimide particles is not greater than 20%; and
a glass transition temperature of the polyimide particles is not greater than 200° C.

12. A three-dimensional polyimide-based body, wherein
the polyimide-based body is formed by a powder-based additive manufacturing process;
an amount of a polyimide in the polyimide-based body is at least 60 wt %; and
the polyimide is a reaction product of a diamine monomer and dianhydride monomer, wherein the diamine monomer is selected from 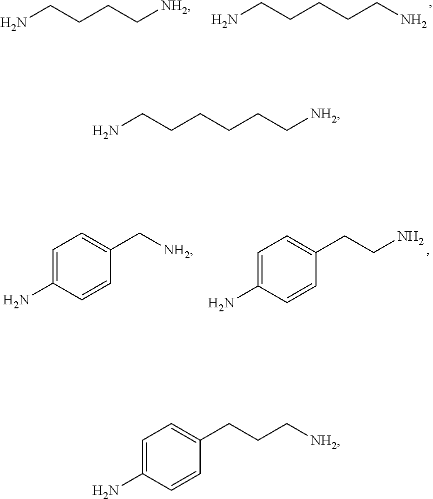
or any combination thereof.

13. The three-dimensional polyimide-based body of claim 12, wherein the powder-based additive manufacturing process is a selective laser sintering (SLS) process.

14. The three-dimensional polyimide-based body of claim 12, wherein the polyimide-based body has a heat deflection temperature (HDT) at 1.8 MPa of at least 120° C.

15. The three-dimensional polyimide-based body of claim 12, wherein an onset melting temperature of a material of the polyimide-based body is not greater than 220° C.

16. The three-dimensional polyimide-based body of claim 12, wherein the dianhydride monomer has a structure of formula (1) or formula (2): 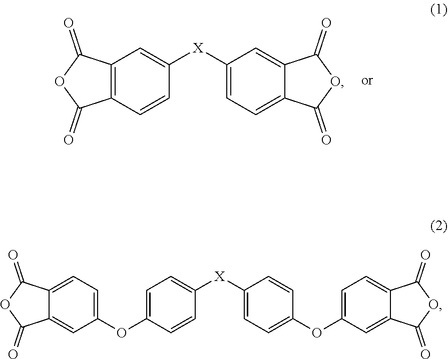
with X being CH₂, CO, O, SO₂, CHY, CY₂, or C₂-C₅ alkyl, Y being CH₃, CH₂F, CHF₂, or CF₃.

17. The three-dimensional polyimide-based body of claim 16, wherein the dianhydride monomer is selected from

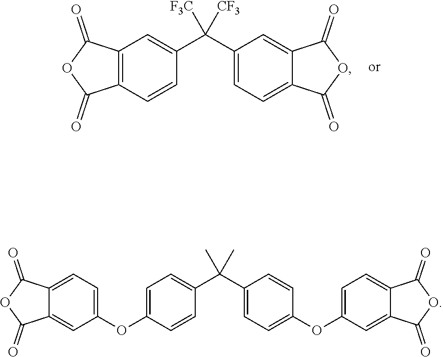 [SMILES: O=C1OC(=O)c2cc(C(c3ccc4c(c3)C(=O)OC4=O)(C(F)(F)F)C(F)(F)F)ccc21 ; "or" ; CC(C)(c1ccc(Oc2ccc3c(c2)C(=O)OC3=O)cc1)c1ccc(Oc2ccc3c(c2)C(=O)OC3=O)cc1]

18. The three-dimensional polyimide-based body of claim 12, wherein the polyimide-based body further comprises an additive, the additive including a thermally conductive filler, an electrically conductive filler, an IR absorber, a flow aid, a flame retardant, a stabilizer, a color dye, or an electrostatic dissipative (ESD) additive.

19. The three-dimensional polyimide-based body of claim 18, wherein the additive is selected from carbon fibers, glass fibers, glass beads, hollow glass beads, a ceramic, a mineral, mica, wollastonite, carbon nano tubes, graphite, graphene, a metal, a metal alloy or any combination thereof.

20. The three-dimensional polyimide-based body of claim 12, wherein the three-dimensional body consists essentially of the polyimide.
